(19) United States
(12) Patent Application Publication
(10) Pub. No.: US 2008/0304031 A1
(43) Pub. Date: Dec. 11, 2008

(54) EXPOSURE APPARATUS

(75) Inventors: Mika Kanehira, Sendai-shi (JP); Shigeru Terashima, Utsunomiya-shi (JP); Yutaka Watanabe, Shioya-gun (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/047,579

(22) Filed: Mar. 13, 2008

(30) Foreign Application Priority Data
Mar. 16, 2007 (JP) 2007-068727
Feb. 21, 2008 (JP) 2008-039930

(51) Int. Cl. G03B 27/42

(52) U.S. Cl. 355/53

(57) ABSTRACT

An exposure apparatus exposes a substrate using light from a light source having a wavelength of 20 nm or smaller, and includes plural optical elements, each of which is configured to reflect the light, plural vacuum chambers, each of which houses one or more of the plural optical elements, and a gas supplier configured to supply to each vacuum chamber independently a gas used to inhibit contaminations that could occur on the optical element housed in each vacuum chamber, wherein the gas supplier supplies different types of gases to the plural vacuum chambers according to an illuminance of an illumined region on the optical element housed in each vacuum chamber.

### BACKGROUND OF THE INVENTION

The present invention relates to an exposure apparatus that uses extreme ultraviolet (“EUV”) light, in particular, uses, as exposure light, light having a wavelength of 20 nm or smaller. This exposure apparatus will be referred to as a “EUV exposure apparatus” hereinafter.

A projection exposure apparatus has conventionally been used to expose a pattern of a reticle (original) onto a wafer (substrate) via a projection optical system. The recent exposure apparatuses have been increasingly required to effectively expose finer patterns, and one proposed EUV exposure apparatus uses the EUV light having a wavelength smaller than that of the UV light to meet the high resolution demands.

The light's absorption index into materials increases in the EUV light wavelength range, and the EUV exposure apparatus accommodates a catoptric optical system in a vacuum chamber. The catoptric optical system needs to maintain an optical performance (reflective characteristic) of each optical element (mirror) for a high throughput. However, the mirror oxidizes or deposits carbon or carbide on its surface due to a residue gas in the vacuum chamber and the influence of degas from the resist applied to a substrate of a wafer. These contaminations would degrade the mirror's optical performance.

Accordingly, Japanese Patent Laid-Open No. (“JP”) 2006-49758 (paragraphs nos. 0006 and 0007, FIG. 1) proposes to introduce a degradation control gas containing at least one of a reducing gas, an oxidizer gas, and a fluorine gas, and maintains a partial pressure of the degrading gas containing at least one of oxygen, water and an organic matter within a predetermined range, thereby preventing mirror's oxidations and carbon deposits.

Other prior art include JP 2002-110539, JP 2003-188096, JP 2001-59901, JP 2005-244015, and Japanese Patent No. 3,467,485.

An overabundant carbide gas that is supplied to prevent oxidations causes carbon or carbide deposits, whereas an overabundant oxygen gas that is supplied to prevent carbon or carbide deposits causes oxidations. Therefore, JP 2006-49758 maintains the partial pressure of the degrading gas in the vacuum chamber within the predetermined range, and supplies a degradation control gas to the entire vacuum chamber. However, the instant inventors have discovered that the partial pressure of the degrading gas in the vacuum chamber is not a sole determinant of the oxidations and carbide deposits but the illuminance has also implications. JP 2006-49758 does not consider the illuminance of each mirror, and this method is less effective to contaminations preventions for each mirror in the catoptric optical system.

A high illuminance mirror is likely to oxidize in its illuminated region, and a low illuminance mirror is likely to deposit carbon and carbide. The illuminance attenuates from the light source to the wafer when the illuminated region has an equal area, but increases as the exposure light converges and decreases as it diverges. After all, the illuminance of an individual mirror needs to be checked. Of course, as a total amount of the degrading gas and the degradation control gas increases, the EUV light is absorbed and the throughput lowers. It is therefore necessary to heed an amount of the degradation control gas.

### SUMMARY OF THE INVENTION

The present invention is directed to an exposure apparatus that efficiently exposes a substrate by inhibiting contaminations of an optical element.

An exposure apparatus according to one aspect of the present invention exposes a substrate using light from a light source having a wavelength of 20 nm or smaller, and includes plural optical elements, each of which is configured to reflect the light, plural vacuum chambers, each of which houses one or more of the plural optical elements, and a gas supplier configured to supply to each vacuum chamber independently a gas used to inhibit contaminations that could occur on the optical element housed in each vacuum chamber, wherein the gas supplier supplies different types of gases to the plural vacuum chambers according to an illuminance of an illumined region on the optical element housed in each vacuum chamber.

An exposure apparatus according to another aspect of the present invention exposes a substrate using light having a wavelength of 20 nm or smaller. The exposure apparatus includes plural optical elements, each of which is configured to reflect the light, a vacuum chamber configured to house the plural optical elements, and a gas supplier configured to insufflate to each optical element independently a gas used to inhibit contaminations that could occur on each optical element, wherein the gas supplier insufflates a different type of gas to each optical element according to an illuminance of an illumined region on each optical element.

A further object and other characteristics of the present invention will be made clear by the preferred embodiments described below referring to accompanying drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic block diagram of an exposure apparatus according to a first embodiment of the present invention.

FIG. 2 is a schematic block diagram of a variation of a gas supplier system shown in FIG. 1.

FIG. 3 is a schematic block diagram of an exposure apparatus according to a second embodiment of the present invention.

FIG. 4 is a schematic block diagram of an exposure apparatus according to a third embodiment of the present invention.

FIG. 5 is a schematic block diagram of an electric potential adjuster applicable to the exposure apparatuses shown in FIGS. 1, 3 and 4.

### DESCRIPTION OF THE EMBODIMENTS

Embodiments of the present invention will now be described in detail in accordance with the accompanying drawings.

### First Embodiment

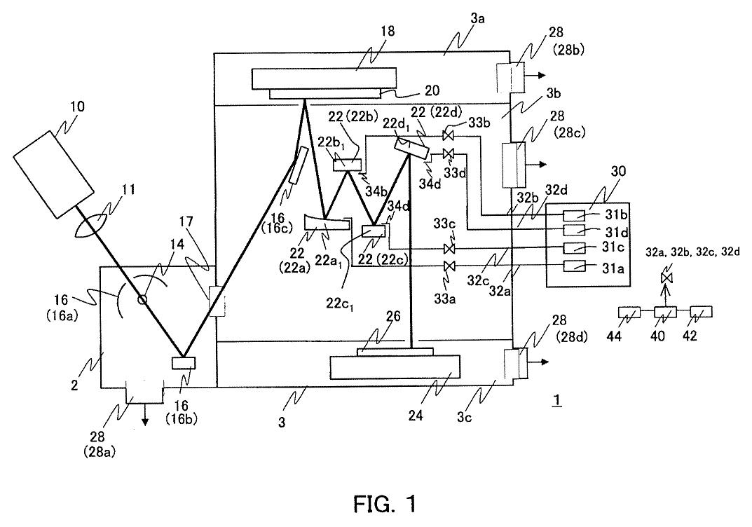

FIG. 1 is a schematic block diagram of a EUV exposure apparatus 1 according to one embodiment of the present invention. A laser beam emitted from a laser 10 is condensed by a lens 11. The EUV light radiated from a plasma spot 14 formed at a condensing point is condensed by an illumination optical system 16. The illumination optical system 16 includes an elliptical mirror 16a, an integrator 16b, and a deflection mirror 16c, and introduces the EUV light to a reflection reticle 20. A projection optical system 22 projects the light reflected from the reflection reticle 20 onto a wafer 26. The reticle 20 is fixed onto a translatable reticle stage 18, and the wafer 26 is fixed onto a translatable wafer stage 24. The EUV exposure apparatus 1 uses light for exposure which has a wavelength between 10 nm and 20 nm, and achieves a high resolution through the short wavelength. The EUV light source may use a synchrotron radiation light source, a discharge induced plasma light source, or the like, other than the laser induced plasma light source (10, 11).

The exposure apparatus 1 has vacuum chambers 2 and 3, and a differential pumping mechanism 17 that maintains a differential pressure between the vacuum chambers 2 and 3. The vacuum chamber 2 houses the elliptical mirror 16a and the integrator 16b. The vacuum chamber 3 houses vacuum chambers 3a, 3b, and 3c. The vacuum chamber 3a houses the reticle stage 18 and the reticle 20. The vacuum chamber 3b houses the defection mirror 16c and the projection optical system 22. The vacuum chamber 3c houses the wafer stage 24 and the wafer 26. Thus, each of the vacuum chambers 2 and 3b houses one or more optical elements.

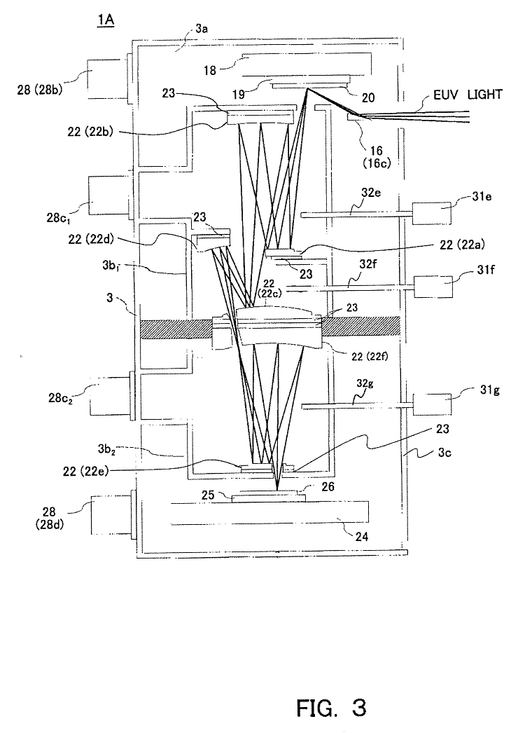

The projection optical system 22 has four mirrors 22a to 22d along an optical path from the light source, but may use a five-mirror system, the following six-mirror system shown in FIG. 3, and an eight-mirror system. Each of the vacuum chambers 2, 3a to 3c is provided with an exhaust system 28 (28a to 28d), thereby preventing attenuations of the EUV light in the air atmosphere and photon scattering. The exhaust system can include a turbo-molecular pump, an ion transfer pump, a dry pump, or the like.

An optical element used for the reticle 20, the illumination optical system 16, and the projection optical system 22 is often coated, for example, with a multilayer film that is made by alternately stacking two materials having different refractive indices in the EUV wavelength range. One typical multilayer coating structure is a lamination of thirty to forty pairs of molybdenum and silicon. For required performance and life, the optical element may further include an intermediate layer made of ruthenium, boron carbide or the like, and a capping layer made of ruthenium, titanium oxide, carbon and a compound or alloy containing carbon.

The EUV exposure apparatus has a gas supply system 30 that supplies a gas to the mirror 22a to 22d individually. The gas supply system 30 has gas sources 31a to 31d, pipes 32a to 32d, valves 33a to 33d, and nozzles 34a to 34d. Component suffixes “a” to “d” in the gas supply system 30 correspond to mirrors 22a to 22d of the projection optical system 22.

The gas sources 31a to 31d store the same gas or different types of gases although at least two of the gas sources 31a to 31d store two different types of gases. The gas of this embodiment contains at least one of oxygen, oxygen containing species, ozone, water, hydrogen, and carbide and may apply, of course, the degradation control gas disclosed in JP 2006-49758. The gas sources 31a to 31d are connected to corresponding pipes 32a to 32, valves 33a to 33d, and nozzles 34a to 34d. The nozzles 34a to 34d insufflate corresponding gases to illuminated regions 22a₁ to 22d₁ on the mirrors 22a to 22d. As a result, a gas suitable for degradation control of the optical performance is selected for and supplied to each mirror.

The valves 33a to 33d are connected to a controller 40, which is, in turn, connected to a memory 42.

The memory 42 stores information about contaminations that could occur in the illuminated regions 22a₁ to 22d₁ on each mirror 22a to 22d and a gas that inhibits the contaminations. The contaminations could occur under the designed illuminance and a residue gas in the vacuum chamber 3b exhausted by the exhaust system 28.

More specifically, an experiment or simulation is performed for the illuminated areas 22a₁ to 22d₁ under the designed illuminance and the residue gas in the vacuum chamber 3b exhausted by the exhaust system 28 to obtain information about types of contaminations formed in the illuminated regions 22a₁ to 22d₁, or as to whether the illuminated area is likely to oxidize or deposit carbon or carbide, about the amount of contaminations formed per unit time, about a type of gas that inhibits the contaminations and contains at least one of oxygen, oxygen containing species, ozone, water, and hydrogen, and carbide, a relationship between a supplied amount of the gas to the vacuum chamber 3b and an inhibiting effect of the contamination, and a relationship between the gas supplied amount and the EUV light absorption amount. The memory 42 stores these pieces of information.

The controller 40 controls a supplied amount of the gas to the mirrors 22a to 22d by controlling opening and closing timings of the valves 33a to 33d in the gas supply system 30 based on the information stored in the memory 42. For example, the controller 40 supplies a carbide gas to the high illuminance mirror 22a, and oxygen or steam to the low illuminance mirror 22d.

A boarder of the illuminance at which the supplied gas type is to be changed depends upon a partial pressure of the residue gas type. In particular, when a gas type containing a carbon compound remains, the boarder of the illuminance changes depending upon the molecular weight and vapor pressure of the carbon compound. The memory 42 stores the boarder of the illuminance determined by an experimental result and a simulation result. For example, the boarder of the EUV light illuminance is 0.5 W/cm² when a hydrocarbon gas having a molecular weight of about 150 conspicuously remains. This value is determined from the experimental result.

This embodiment determines the types of gases stored in the gas sources 31a to 31d based on the previous experiment or simulation. However, if the maintenance requires supplies of plural types of gases, the gas sources 31a to 31d may store plural types of gases, for example, (although the number of gas sources is not limited) and a switch may switch a channel between each gas source and each nozzle.

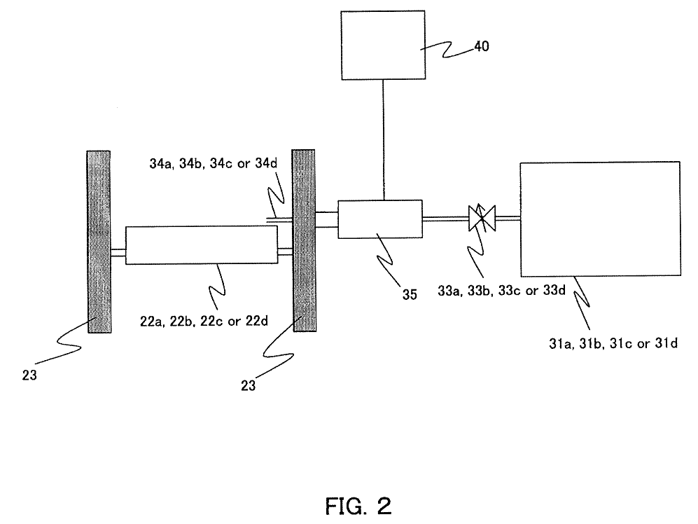

The gas supplied to the mirrors 22a to 22d is to inhibit contaminations for the optical performance of the mirror. In an example, FIG. 2 shows a gas supply system where a carbon capping layer is formed on the mirror surface.

In FIG. 2, 23 denotes a mirror holder, and valves 33a to 33d denote variable valves, and 35 denotes a moving mechanism. The gas supply system is made movable, and may be moved somewhere near the mirrors 22a to 22d for the gas supply. A scanning function may be annexed so as to scan the illuminated region on the mirror surface, because the illuminated region is illuminated by the EUV light and deposits the contaminations. A supply of the gas may be a pulsed blow of the gas or a continuous supply of the gas using the principle of the molecular leak.

When the carbon or carbide deposits on the mirror surface in exposure of the wafer 26 and lowers the optical performance of the mirror, the gas is supplied to remove the carbon or carbide deposits in the exposure time that executes the exposure of the wafer 26 or non-exposure time that stops the exposure of the wafer 26 until the mirror restores its intended performance. The gas may be, for example, the gas that contains wafer and oxygen molecules, and the gas that contains argon, thereby removing carbon and carbide from the mirror surface using a chemical reaction and etching.

The mirror surface may degrade due to oxidations and erosions depending upon the exposure light intensity, and the residue gas near the mirror, in particular, the partial pressure of the water. When the mirror is made of silicon, etc., the oxidation is fatal. One solution for this problem is to supply a carbide containing gas to the optical element surface during exposure of the wafer 26, weakening reactions between the optical element surface material and the water molecules and consequently inhibiting oxidations.

The illuminance of the exposure light and the atmosphere (residue gas species) are different among the optical elements in the exposure apparatus 1, and the types and degrees of contaminations are different for each optical element. The contaminations and the EUV light absorption amount in the gas can reduce by supplying a proper amount of a gas suitable for contaminations control as in this embodiment, and the throughput can improve with a maintained optical performance of the optical element.

The controller 40 of this embodiment controls gas supplying and stopping timings based on the information stored in the memory 4, but may provide more precise control in cooperation with a detector 44 that detects mirror's degradation or restoration or the residue gas component or supplied gas component, in addition to the information in the memory 42. In this case, the controller 40 controls gas supplying and stopping timings based on the detection result of the detector 44. The detector 44 can be an image pickup unit, a mass spectrograph that monitors a residue gas near the mirror, an illuminance meter that measures the mirror's illuminance, or an ammeter that measures a current value so as to predict the surface state of the mirror's surface.

### Second Embodiment

While the first embodiment houses the mirrors 22a to 22d in one vacuum chamber 3b, the second embodiment houses them in different vacuum chambers according to the types of supplied gases. FIG. 3 shows principle part of a EUV exposure apparatus 1A of this embodiment.

The vacuum chamber 3 has vacuum chambers 3a, 3b₁, 3b₂, and 3c. The vacuum chamber 3a houses the reticle stage 18, the reticle chuck 19, and the reticle 20. The vacuum chamber 3b₁ houses the mirrors 22a to 22d in six-mirror projection optical system 22. The vacuum chamber 3b₂ houses the mirrors 22e and 22f in the projection optical system 22. 23 denotes a mirror holder. The vacuum chamber 3c houses the wafer stage 24, the wafer chuck 25, and the wafer 26. The vacuum chambers 3a and 3c are substantially the same as those shown in FIG. 1. Moreover, while the exposure apparatus includes plural vacuum chambers, such as a vacuum chamber that houses an illumination optical system (not shown), a vacuum chamber that houses a light source (not shown), and a vacuum chamber used to exchange a wafer and a reticle, this embodiment illustrates only the projection optical system.

Among the vacuum chambers housing the optical elements in the projection optical system, the vacuum chamber 3b₁ near the light source is exhausted from the exhaust system 28c₁, and the gas sources 31e and 31f are connected to the pipes 32e and 32f via valves (not shown). The gas of the gas sources 31e and 31f in this embodiment is the gas containing carbide. This is because the mirrors 22a to 22d that are located near the object plane of the projection optical system 22 and housed in the vacuum chamber 3b₁ are subject to comparatively high illuminance and likely to oxidize. The tips of the pipes 32e and 32f are provided with nozzles (not shown), which extend somewhere near the illuminated regions on the mirrors 22a to 22d, but are omitted for convenience for illustrations.

Among the vacuum chambers housing the optical elements in the projection optical system, the vacuum chamber 3b₂ near the wafer 26 is exhausted by the exhaust system 28c₂, and the gas sources 31g is connected to the pipe 32g via the valve (not shown). The gas in the gas source 31g in this embodiment contains at least one of oxygen, oxygen containing spices, ozone, water, and hydrogen. This is because the mirror 22f that is located near the pupil plane in the projection optical system and housed in the vacuum chamber 3b₂ receives divergent light at comparatively low illuminance, and the mirror 22e that is located near the image plane of the projection optical system 22 and housed in the vacuum chamber 3b₂ is exposed to a carbon containing degas from the resist of the wafer 26 and is likely to deposit carbon or carbide. The tip of the pipe 32g is provided with a nozzles (not shown), which extends somewhere near the illuminated region on the mirrors 22e and 22f, but is omitted for convenience for illustrations.

Thus, the mirror group can be simultaneously controlled by supplying the same gas like this embodiment. While FIG. 2 omits the controller 40 and the memory 42, they are similar to FIG. 1.

This embodiment divides the projection optical system into the vacuum chamber 3b₁ and the vacuum chamber 3b₂. The invention of this embodiment is applicable when each of the illumination optical system and the projection optical system is housed in one vacuum chamber. In this case, an oxidation preventive gas, such as a gas containing a carbon compound, is introduced into the vacuum chamber that houses the illumination optical system, and a carbon deposit preventive gas that contains at least one of oxygen, oxygen containing species, ozone, water, and hydrogen, is introduced into the vacuum chamber that houses the projection optical system.

### Third Embodiment

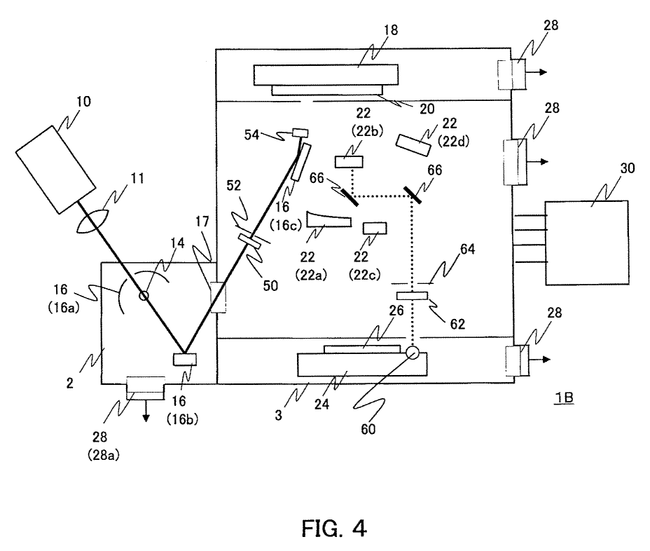

FIG. 4 is a schematic block diagram of the EUV exposure apparatus 1B according to a third embodiment. The EUV exposure apparatus 1B has a basic structure similar to that of the EUV exposure apparatus 1, but is different in that the EUV exposure apparatus 1B can control the illuminance, the wavelength and the illuminated region of the exposure light, and includes a mechanism configured to generate necessary electromagnetic waves. In addition, another light source different from the exposure light may be provided as necessary.

In the maintenance, the exposure apparatus 1B irradiates the electromagnetic waves onto the optical elements as necessary, and the illuminance, wavelength, and the illuminated region of the electromagnetic waves are adjusted suitable for each optical element. In addition, the illuminance, wavelength, and the illuminated region of the irradiated electromagnetic waves may be made variable according to the state of each optical element.

The exposure apparatus 1B provide the illumination optical system 16 with a filter 50 that adjusts the exposure light intensity, and an aperture or iris 52 that adjusts the size of the illuminated area. In addition, a beam damper 54 may be arranged as necessary which prevents an irradiation of the electromagnetic wave onto an undesired region. These components may be made movable, and moved somewhere on the optical path of the exposure light in use.

The illumination optical system 16 irradiates the exposure light having a high illuminance during exposure of the wafer 26. When the optical element has a carbon capping layer, the capping layer is consumed. When the capping layer is consumed and the optical element beneath it becomes bare, the optical element surface oxidizes and can remarkably degrade. These optical elements need be maintained so as to repair the capping layer, for example, after a certain time period passes before a consumption of the capping layer is completed. When the intensity of the initial exposure light is too strong, the filter 50 etc. may be used to lower the intensity and the aperture or iris 52 is used to adjust the illuminated region in irradiating the exposure light onto the optical element. The mechanism described in the first embodiment may be used to introduce the proper carbide containing gas at a proper partial pressure for efficient repair of the capping layer and restoration of the oxygen resistance.

The mirror close to the wafer 26 among the mirrors in the projection optical system 22 is subject to expose to degas from the resist at the top of the wafer 26, and likely to deposit carbon or carbide. This embodiment mounts a UV lamp 60 as another light source onto the wafer stage 24 that is comparatively close to the optical element that is likely to deposit them. The optical element is cleansed by irradiating the UV onto the optical element under a gas that contains at least one of oxygen, oxygen containing species, ozone, water, and hydrogen. In addition, a collimator 62 and aperture or iris 64 are mounted near the light source so as to convert the light from the light source into a desired shape as needed. They are movable, and can be moved somewhere in the optical path of the exposure light, etc. in use.

An alternative embodiment provides an optical system that irradiates the UV at necessary illuminance and wavelength onto an illuminated region on the optical element farthest from the resist in the projection optical system 22. This embodiment arranges a movable and rotatable ultraviolet reflection mirror 66 near the projection optical system so as to irradiate the UV onto any optical element in the projection optical system.

In addition, an alternative embodiment mounts a mirror on the wafer stage 24, and introduces the light from another light source from the outside of the vacuum chamber 3 via a window. The other light source may use not only continuous light like a lamp but also pulsed light like a laser. Similarly, the reticle stage may be provided with another light source.

### Fourth Embodiment

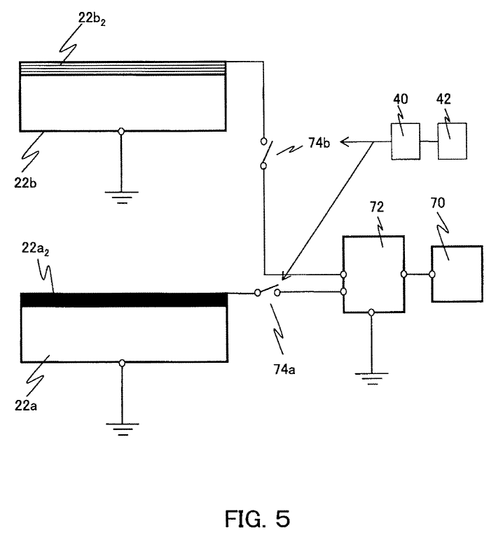

FIG. 5 is a block diagram of principal part of an electric potential adjuster applicable to the EUV exposure apparatuses 1 to 1B. FIG. 5 provides the capping layer 22a₂ to 22b₂ to the tops of the mirrors 22a and 22b. The mirrors 22a and 22b are grounded thorough the holder 23 (not shown).

A trigger generator 70 and a power source or waveform shaper (referred to as a “power source” hereinafter) 72 is connected to a switch 74a connected to the capping layer 22a₂. Similarly, the trigger generator 70 and the power source 72 is connected to a switch 74b connected to the capping layer 22b₂. The trigger generator 70, the power source 72, and the switches 74a and 74b constitute the electric potential adjuster.

The electric potential adjuster applies desired charges to the capping layer of each mirror independently at desired timings. The power source 72 may have a channel so as to control applied charges for each mirror.

During exposure of the wafer 26, the illuminance of the exposure light irradiated onto each optical element differs, and a surface electrification differs for each optical element. The electrification state varies according to the film structure of the optical element and a material of the substrate. For the optical element that receives the light having a low illuminance and emits few secondary electrons, the generated electric charges are immediately neutralized if the optical element surface is grounded. However, when the optical element receives the light having a high illuminance or emits more secondary electrons is likely to become electrified. The electric charges stored on the surface cause contaminations, and need to be neutralized depending upon the electrification degree.

This embodiment pulses predetermined negative charges to the mirror surface in synchronization with the exposure light using the electric potential adjuster that applies electric charges, thereby immediately neutralizing the electric charges on the mirror surface. The controller 42 controls the electric charge amount to be applied to the optical element and the opening and closing timings of the switches 74a and 74b based on the information stored in the memory 42.

On the contrary, in repairing the carbon capping film, the controller 40 may generate a state which is likely to produce the capping film by applying proper electric charges. This information is previously stored in the memory 42 through an experiment or simulation.

A device, such as a semiconductor device and a liquid crystal device, is manufactured by the steps of exposing a photosensitive agent applied substrate (wafer) using the exposure apparatus of one of the above identified embodiments, and developing the substrate.

As many apparently widely different embodiments of the present invention can be made without departing from the sprit and scope thereof, it is to be understood that the invention is not limited to the specific embodiments thereof except as defined in the claims. For example, the optical element from which the contaminations are to be removed may be one in the illumination optical system and other optical elements.

The entire disclosure of Japanese Patent Applications Nos. 2007-068727, filed on Mar. 16, 2007, and 2008-039930, filed on Feb. 21, 2008 including claims, specification, drawings and abstract incorporated herein by reference in its entirety.

What is claimed is:

1. An exposure apparatus configured to expose a substrate using light from a light source having a wavelength of 20 nm or smaller, said exposure apparatus comprising:
plural optical elements, each of which is configured to reflect the light;
plural vacuum chambers, each of which houses one or more of the plural optical elements; and
a gas supplier configured to supply to each vacuum chamber independently a gas used to inhibit contaminations that could occur on the optical element housed in each vacuum chamber,
wherein the gas supplier supplies different types of gases to the plural vacuum chambers according to an illuminance of an illumined region on the optical element housed in each vacuum chamber.

2. An exposure apparatus according to claim 1, wherein the gas supplier supplies different types of gases with different supplied amounts to the plural vacuum chambers according to the illuminance of the illumined region on the optical element housed in each vacuum chamber.

3. An exposure apparatus according to claim 1, further comprising:
a memory configured to store information about the gas that inhibits contaminations that could occur in the illuminated region of the optical element housed in each vacuum chamber under a residue gas in the vacuum chamber in exposure of the substrate and with a set illuminance; and
a controller configured to control, based on the information stored in the memory, a type of gas that inhibits the contaminations and is supplied by the gas supplier.

4. An exposure apparatus according to claim 1, wherein the gas supplier supplies to the vacuum chamber that is closer to the substrate a gas that contains oxygen, oxygen containing species, ozone, water, and hydrogen, and supplies to the vacuum chamber that is closer to the light source a gas that contains a carbon compound.

5. An exposure apparatus according to claim 1, wherein the gas supplier supplies the different types of gases when the substrate is exposed.

6. An exposure apparatus according to claim 1, wherein at least one optical element among the plural optical elements is irradiated with light having a wavelength higher than that of the light used for exposure when the gas supplier supplies the gas.

7. An exposure apparatus according to claim 1, further comprising an electric potential adjuster configured to adjust a potential of each optical element.

8. An exposure apparatus configured to expose a substrate using light having a wavelength of 20 nm or smaller, said exposure apparatus comprising:
plural optical elements, each of which is configured to reflect the light;
a vacuum chamber configured to house the plural optical elements; and
a gas supplier configured to insufflate to each optical element independently a gas used to inhibit contaminations that could occur on each optical element,
wherein the gas supplier insufflates a different type of gas to each optical element according to an illuminance of an illumined region on each optical element.

9. A device manufacturing method comprising the steps of:
exposing a substrate using an exposure apparatus according to claim 1; and
developing the substrate that has been exposed.

10. A device manufacturing method comprising the steps of:
exposing a substrate using an exposure apparatus according to claim 8; and
developing the substrate that has been exposed.
